(19) United States
(12) Patent Application Publication
(10) Pub. No.: US 2017/0038955 A1
(43) Pub. Date: Feb. 9, 2017

(54) WALLPAPER SWITCHING METHOD AND DEVICE

(71) Applicants: LE HOLDINGS (BEIJING) CO., LTD., Beijing (CN); Lemobile Information Technology (Beijing) Co., Ltd., Beijing (CN)

(72) Inventor: Hongtao ZHAO, Beijing (CN)

(21) Appl. No.: 15/238,586

(22) Filed: Aug. 16, 2016

Related U.S. Application Data
(63) Continuation of application No. PCT/CN2016/087336, filed on Jun. 27, 2016.

(30) Foreign Application Priority Data
Aug. 6, 2015 (CN) 201510478766.5

(51) Int. Cl. G06F 3/0484; H04M 1/247; G06F 3/0488

(52) U.S. Cl. CPC G06F 3/04847; G06F 3/0488; H04M 1/2477; H04M 1/67

(57) ABSTRACT

The embodiments of the present disclosure provide a wallpaper switching method and device. The method specifically comprises: monitoring an operation of a user on a touch screen; when the operation is a sliding operation which corresponding to a preset switching condition, or the operation is an operation aiming at a wallpaper switching control, modifying a pre-associated storage object according to the operation, wherein the storage object is a storage object of a wallpaper management service identifier of an application; sending modification notification information to the application. According to the embodiments of the present disclosure, the wallpaper switching efficiency can be improved.

### CROSS-REFERENCE TO RELATED APPLICATIONS

The present disclosure is a continuation of International Application No. PCT/CN2016/087336, filed on Jun. 27, 2016; which is based upon and claims priority to Chinese Patent Application No. 201510478766.5, entitled “WALLPAPER SWITCHING METHOD AND DEVICE”, filed on Aug. 6, 2015, the entire contents of all of which are incorporated herein by reference.

### FIELD OF TECHNOLOGY

The present disclosure generally relates to the technical field of communication, and particularly relates to a wallpaper switching method and device.

### BACKGROUND

With rapid development of information technology, mobile phones are popular in people's lives, and most mobile phones have a function of switching wallpaper.

An existing wallpaper switching method can support wallpaper switching by way of sliding a mobile phone screen or by way of shaking the mobile phone. A corresponding switching process specifically includes: in the wallpaper switching method, according to user's demand, firstly finding and switching on a switch of switching wallpaper in functional levels such as wallpaper application and mobile phone settings; then returning to a wallpaper interface for switching wallpaper by way of shaking the mobile phone; and after switching to a satisfactory wallpaper of the user, returning to the functional levels such as wallpaper application and mobile phone settings to find and switch off a wallpaper switch.

From the user's perspective, the switching operation of the wallpaper switching method needs a tedious flow so that the wallpaper switching efficiency is extremely reduced.

### SUMMARY

The embodiments of the present disclosure disclose a wallpaper switching method and device for overcoming the shortcoming in the prior that the flow is tedious, so that the wallpaper switching efficiency is improved.

According to one aspect of the present disclosure, the embodiments of the present disclosure provide a wallpaper switching method, including:
monitoring an operation. on a touch screen from a user;
when the operation is a sliding operation which corresponding to a preset switching condition, or, when the operation is an operation with respect to a wallpaper switching control, modifying a pre-associated storage object according to the operation, wherein the storage object is a storage object of a wallpaper management service identifier of an application; and
sending a modification notification information of the storage object to the application.

According to another aspect of the present disclosure, the embodiments of the present disclosure provide a wallpaper switching device, including: at least one processor; and a memory communicably connected with the at least one processor for storing instructions executable by the at least one processor, wherein execution of the instructions by the at least one processor causes the at least one processor to:
monitor an operation on a touch screen from a user;
when the operation is a sliding operation which corresponding to a preset switching condition, or, when the operation is an operation with respect to a wallpaper switching control, modify a pre-associated storage object according to the operation, wherein the storage object is a storage object of a wallpaper management service identifier of an application; and
send a modification notification information of the storage object to the application.

According to another aspect of the present disclosure, the present disclosure provides a computer program, which includes a computer readable code. When the computer readable code operates in a mobile terminal, the mobile terminal executes the wallpaper switching method.

According to another aspect of the present disclosure, the present disclosure provides a computer readable medium, wherein the computer program is stored therein.

The present disclosure has the beneficial effects that: according to the wallpaper switching method and device provided by the embodiments of the present disclosure, when the operation of the user on the touch screen is the sliding operation which corresponding to the preset switching condition, or the operation is the operation aiming at the wallpaper switching control, the first application can modify the pre-associated storage object according to the operation and send the modification notification information of the storage object to the second application, so that the second user receiving the modification notification information acquires the wallpaper switching identifier in the storage object and determines whether the wallpaper management service is opened or the wallpaper management service is closed according to the identifier. Compared with the defect in the prior art, where the switching flow is tedious as the switch for switching the wallpaper is located the functional levels such as wallpaper application or mobile phone settings, in the embodiments of the present disclosure, switching of the wallpaper management service of the second application can be accomplished through the first application, and the first application can be an application capable of displaying the wallpaper, for example, a screen-locking application or a desktop application, so that switching of the wallpaper management service can be realized on the premise of not entering the functional levels such as wallpaper application or mobile phone settings in the embodiments of the present disclosure. Therefore, the wallpaper switching flow can be simplified, so that the wallpaper switching efficiency can be improved.

The above description is only the summary of the technical scheme of the present disclosure. In order to understand the technical means of the present disclosure more clearly to implement the technical means according to the content of the description, and to make the above and other purposes, characteristics and advantages of the present disclosure more obvious and understandable, detailed description of the present disclosure are listed below.

### BRIEF DESCRIPTION OF FIGURES

In order to illustrate the technical scheme in the embodiments of the present disclosure or in the prior art more clearly, the drawings needed to be used in the embodiments of the present disclosure are simply introduced. It is obvious that the drawings in the description are some embodiments of the present disclosure. As far as those ordinary skilled in the art is concerned, on the premise of not contributing creative labor, other drawings can be further obtained according to the drawings.

FIG. 1 is a step flow diagram of a first embodiment of the wallpaper switching method according to the present disclosure.

FIG. 2 is a step flow diagram of a second embodiment of the wallpaper switching method according to the present disclosure.

FIG. 3 is a step flow diagram of a third embodiment of the wallpaper switching method according to the present disclosure.

FIG. 4 is schematic diagram of a vertical sliding operation in a sliding direction on the touch screen in the wallpaper switching method provided according to the present disclosure.

FIG. 5 is a step flow diagram of a fifth embodiment of the wallpaper switching method according to the present disclosure.

FIG. 6 is a structural schematic diagram of a first embodiment of the wallpaper switching device.

FIG. 7 is a structural schematic diagram of a second embodiment of the wallpaper switching device according to the present disclosure.

FIG. 8 is a structural schematic diagram of a third embodiment of the wallpaper switching device according to the present disclosure.

FIG. 9 is a structural schematic diagram of a fourth embodiment of the wallpaper switching device according to the present disclosure.

FIG. 10 is a structural schematic diagram of a fifth embodiment of the wallpaper switching device according to the present disclosure.

FIG. 11 is a structural schematic diagram of a sixth embodiment of the wallpaper switching device according to the present disclosure.

FIG. 12 schematically depicts a block diagram of a mobile terminal for executing the method according to the present disclosure.

FIG. 13 schematically depicts a storage unit for keeping or carrying a program code, which realizes the method according to the present disclosure.

### DESCRIPTION OF THE EMBODIMENTS

In order to make the purpose, technical scheme and advantages of the embodiments of the present disclosure more clear, the technical scheme according to the embodiments of the present disclosure are dearly and completely described in connection with the drawings in the embodiments of the present disclosure. Obviously, the described embodiments are part of embodiments of the present disclosure rather than all the embodiments. On the basis of the embodiments of the present disclosure, all the other embodiments obtained by those ordinary skilled in the art on the premise of not contributing creative labor shall fall into the scope of the present disclosure.

### First Embodiment of the Method

With reference of FIG. 1, the step flow diagram of the first embodiment of the wallpaper switching method according to the present disclosure is illustrated. The method can specifically include the steps of:
Step 101, a first application monitors an operation of a user on a touch screen;
Step 102, when the operation is a sliding operation meeting a preset switching condition, or, the operation is performed with respect to a wallpaper switching control, the first application modifies a pre-associated storage object according to the operation, where the storage object is a storage object of a wallpaper management service identifier of a second application;
Step 103, the first application sends the modification notification information of the storage object to the second application.

In conclusion, in the wallpaper switching method provided according to the embodiment of the present disclosure, when the operation of the user on the touch screen is the sliding operation meeting the preset switching condition, or the operation is performed with respect to the wallpaper switching control, the first application can modify the pre-associated storage object according to the operation and send the modification notification information of the storage object to the second application, and then the second application receives the modification notification information, acquires the wallpaper switching identifier in the storage object and determines whether the wallpaper management service will be started according to the identifier. Compared with the defect that the switching process is tedious as the switch for switching the wallpaper is located in the functional levels such as wallpaper application or mobile phone settings in the prior art, in the embodiment of the present disclosure, switching of the wallpaper management service of the second application can be accomplished through the first application, and the first application can be an application capable of displaying the wallpaper, for example, a screen-locking application or a desktop application, so that switching of the wallpaper management service can be realized without entering the functional levels such as wallpaper application or mobile phone settings in the embodiment of the present disclosure. Therefore, the wallpaper switching process can be simplified, so that the wallpaper switching efficiency can be improved.

### Second Embodiment of the Method

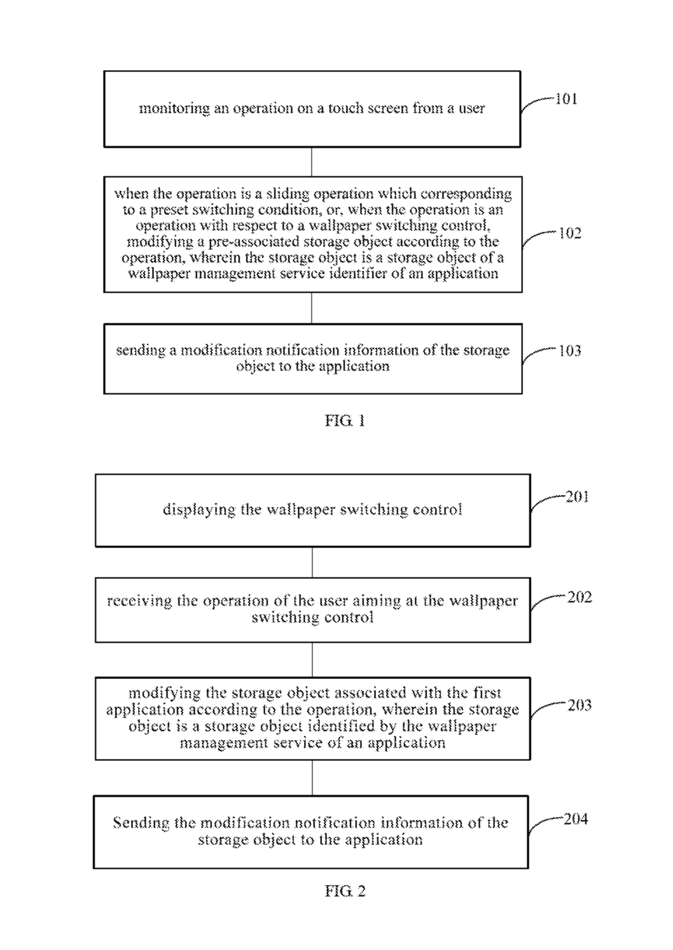

With reference of FIG. 2, the step flow diagram of the second embodiment of the wallpaper switching method according to the present disclosure is illustrated. The method can specifically include the steps as below.

Step 201, a first application displays a wallpaper switching control.

The embodiment of the present disclosure can be applied to mobile terminals such as a mobile phone and a tablet personal computer, for switching the wallpaper management service of a second application through the wallpaper switching control located in the first application, so that the wallpaper switching process can be simplified and the wallpaper switching efficiency can be improved, and therefore, the usage experience of the user is increased.

In an embodiment of the present disclosure, the first application is a screen-locking application that can display the wallpaper switching control on a screen-locking interface. The screen-locking application is an expanded application based on the mobile terminal, and has the primary function of preventing misoperation of the mobile phone. In a specific embodiment of the present disclosure, the screen-locking application can display the screen-locking interface in a screen-looking state of the mobile terminal and can display the wallpaper switching control in the screen-locking interface; it is understandable that the wallpaper switching control can be located in any position of the screen-locking interface, for example, a position that is not conflicted with characters existing in the screen-locking interface and etc. The embodiment of the present disclosure does not limit the specific position of the wallpaper switching control in the screen-locking interface.

In another embodiment of the present disclosure, the first application is a desktop application. In a process of using the mobile terminal by the user, the desktop application can display the wallpaper switching control on the desktop; it is understandable that the wallpaper switching control can be located in any position of the desktop, for example, a position that is not conflicted with icons existing on the desktop. The embodiment of the present disclosure does not limit the specific position of the wallpaper switching control on the desktop.

It is understandable that the screen-locking application and desktop application are only specific examples of the first application rather than application limitation on the first application in the embodiment of the present disclosure. Actually, any application for displaying the wallpaper can be used as the first application. The embodiment of the present disclosure does not limit the specific first application.

In the embodiment of the present disclosure, the wallpaper switching control can specifically include two states: being turned on and off; the two states can be used for identifying the two states when the wallpaper management service is turned on or off, respectively.

In an embodiment of the present disclosure, the wallpaper management widget can be a switch. For example. when the switch is located on the left side, the state of the switch is identified as being turned on, and when the switch is located on the right side, the state of the switch is identified as being turned off; or when the switch is located on the left side, the state of the switch is identified as being turned off, and when the switch is located on the right side, the state of the switch is identified as being turned on, etc.

In another embodiment of the present disclosure, the wallpaper switching control further can be check boxes. There may be one check box. When the check box is selected, the state of the check box can be identified as being turned on, and when the check box is not selected, the state of the check box can be identified as being turned off. Alternatively, there may be two check boxes. When the two check boxes separately correspond to the turned on and off state, only one of the two check boxes is in a selected state at the same moment.

It is understandable that the switch and the check boxes are only used as examples of the wallpaper switching control rather than limitation on the wallpaper switching control. Actually, the wallpaper switching control can be represented in various manners. The control capable of identifying the two states, being turned on and off, of the wallpaper management service can be feasible. The embodiment of the present disclosure does not limit specific representation manner of the wallpaper switching control.

Step 202, the first application receives the operation with respect to the wallpaper switching control from the user.

In the embodiment of the present disclosure, assuming that the wallpaper switching control is the switch, the operation with respect to the wallpaper switching control from the user may specifically include switching the state of the switch from on to off or from off to on by switching the switch; assuming that the wallpaper switching control is the check boxes, the operation with respect to the check boxes from the user may specifically include switching the state of the check boxes from off to on by selecting the check boxes, or switching the state of the check boxes from on to off by undoing the selecting of the check boxes.

Step 203, the first application modifies the storage object associated with the first application according to the operation, wherein the storage object is a storage object identified by the wallpaper management service of the second application.

In the embodiment of the present disclosure, the storage object can be used for storing wallpaper management service identifier corresponding to the state of the wallpaper switching control, and the wallpaper management service identifier of the second application is used for identifying whether the wallpaper management service is on or off. For example, when the state of the wallpaper switching control is switched to be on, the wallpaper management service identifier in the storage object can be correspondingly modified to be on; when the state of the wallpaper switching control is switched to be off, the wallpaper management service identifier in the storage object can be correspondingly modified to be off.

It should be noted that a mapping relationship between the first application and the storage object can be pre-established; therefore, when the operation is received, the storage object pre-associated with the first application corresponding to the operation can be acquired according to the mapping relationship. In addition, as the storage object is an object of the second application, the operating right of the storage object by the second application can be opened to the first application, so as to realize modification on the storage object by the first application.

In an embodiment of the present disclosure, the storage object can be lightweight storage SharedPreference. When the second application is established in the SharedPreference, right of the SharedPreference can be set as being readable and rewritable by other applications, wherein the other applications may include the first application, thus, when the state of the wallpaper switching control is changed, the first application modifies the SharedPreference according to change of the wallpaper switching control, wherein modification on the SharedPreference can be modification on the wallpaper management service identifier in the SharedPreference.

It is understandable that the SharedPreference is only an example of the storage object rather than limitation on the storage object. Actually, assemblies in the application capable of storing the wallpaper switching identifier can be feasible, for example, a lightweight database SQfile, a native object File, a broadcast Network and etc.; therefore, the embodiment of the present disclosure does not limit the storage object.

Step 204, the first application sends the modification notification information of the storage object to the second application.

In the embodiment of the present disclosure, the modification notification information of the storage object sent by the first application to the second application is used for informing the second application that the storage object is modified, so that the second application receiving the modification notification information acquires the wallpaper switching identifier in the current storage object and determines whether the wallpaper management service is turned on or off according to the wallpaper switching identifier.

In an embodiment of the present disclosure, after the storage object associated by the wallpaper switching control is modified, the first application may send the modification notification information of the storage object to the second application in a broadcast mode, that is, invoking a broadcast receiver, where other applications may include the second application; that is, the first application may invoke the broadcast receiver to send the modification notification information to the second application so as to inform the second application that the storage object is modified.

It is understandable that the broadcast mode is only an example of a sending mode for sending the modification notification information to the second application by the first application rather than application limitation on the sending mode. Actually, the modes for realizing communication between two processes can be used as the sending modes. The modes for realizing communication between two processes can specifically include Activity, Content Provider, AIDL (Android Interface definition language) etc. The embodiment of the present disclosure does not limit the specific sending modes.

In conclusion, according to the wallpaper switching method provided by the embodiment of the present disclosure, after receiving the operation with respect to the wallpaper switching control from the user, the first application can modify the associated storage object by the wallpaper switching control according to the operation and send the modification notification information of the storage object to the second application, so that the second user receiving the modification notification information acquires the wallpaper switching identifier in the storage object and determines whether the wallpaper management service is turned on or off according to the identifier; compared with the defect that in the prior art, the switching flow is tedious as the switch for switching the wallpaper is located the functional levels such as wallpaper application or mobile phone settings, in the embodiment of the present disclosure, the wallpaper switching control may be located in the first application different from the second application and the first application can be the application for displaying the wallpaper, for example, the screen-locking application or the desktop application, so that switching of the wallpaper management service can be realized without entering the functional levels such as wallpaper application or mobile phone settings in the embodiment of the present disclosure. Therefore, the wallpaper switching flow can be simplified, so that the wallpaper switching efficiency can be improved.

### Third Embodiment of the Method

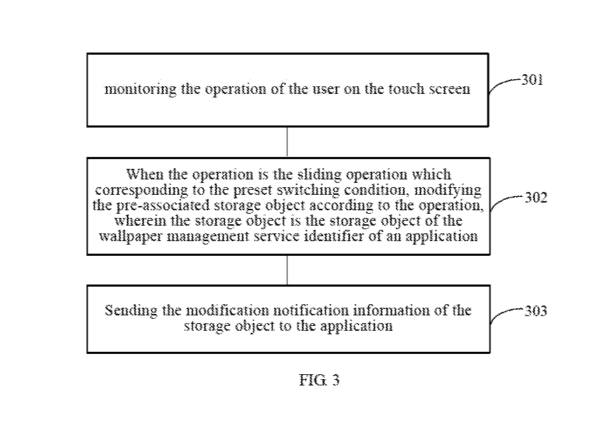

With reference of FIG. 3, the step flow diagram of the third embodiment of the wallpaper switching method according to the present disclosure is illustrated. The method can specifically include the steps as below.

Step 301, a first application monitors a sliding operation on a touch screen from a user.

The embodiment of the present disclosure can be applied to mobile terminals such as a mobile phone and a tablet personal computer for switching the wallpaper management service of a second application through the sliding operation performed in the first application, so that the wallpaper switching flow can be simplified and the wallpaper switching efficiency can be improved, and therefore, the usage experience of the user is increased.

Step 302, when the operation is the sliding operation meeting the preset switching condition, the first application modifies the pre-associated storage object according to the operation, where the storage object is the storage object of the wallpaper management service identifier of the second application.

In an embodiment of the present disclosure, the preset switching condition may be specifically a vertical sliding operation on the touch screen.

In the embodiment of the present disclosure, the step that the first application modifies the associated storage object by the first application according to the sliding operation may be specifically below.

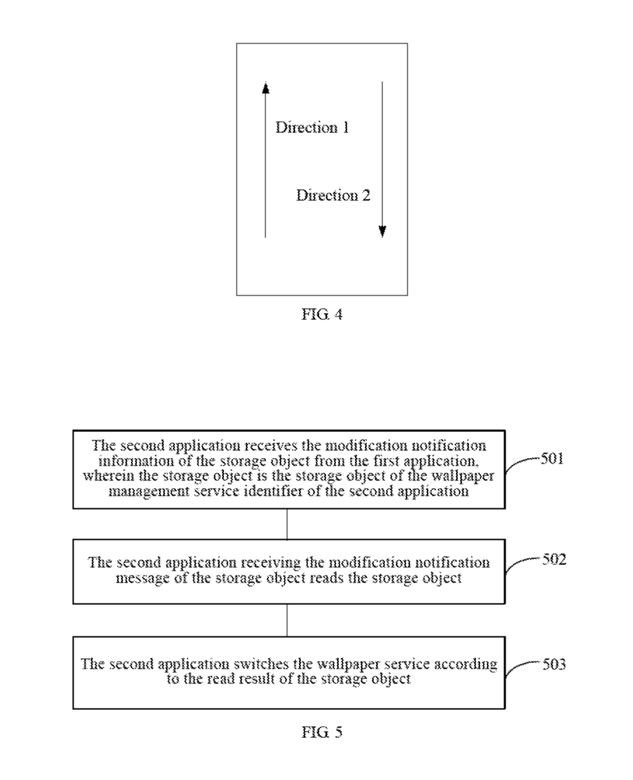

With reference to the FIG. 4, the schematic diagram of the vertical sliding operation in the sliding direction on the touch screen according to the wallpaper switching method provided by the present disclosure is illustrated. When the direction of the vertical sliding operation on the touch screen is the direction 1 shown in the FIG. 4, the wallpaper management service identifier in the storage object can be correspondingly modified to be on; when the direction of the vertical sliding operation on the touch screen is the direction 2 shown in the FIG. 4, the wallpaper management service identifier in the storage object can be correspondingly modified to be off.

Or, when the direction of the vertical sliding operation on the touch screen is the direction 1 shown in the FIG. 4, the wallpaper management service identifier in the storage object can be correspondingly modified to be off; when the direction of the vertical sliding operation on the touch screen is the direction 2 shown in the FIG. 4, the wallpaper management service identifier in the storage object can be correspondingly modified to be on.

In another embodiment of the present disclosure, the preset switching condition may be specifically a pressing operation on the touch screen at the same time of transverse sliding operation, where the pressing operation can be a volume button; the step that the first application modifies the associated storage object by the first application according to the sliding operation may be specifically as follows: when the wallpaper management service identifier in the storage object can be correspondingly modified to be on, and when the transverse sliding operation on the touch screen is performed, the pressing operation of reducing the volume is performed, so that the wallpaper management service identifier in the storage object can be correspondingly modified to be off.

It is understandable that the pressing operations when the vertical sliding operation on the touch screen and the transverse sliding operation on the touch screen at the same are just two examples of the preset switching condition of the embodiment of the present disclosure rather than limitation on the preset switching condition of the embodiment of the present disclosure. Actually, operations that are not conflicted with operations of existing unlocking gestures or desktop switching gestures are feasible, for example, existing unlocking gestures or desktop switching gestures use a single finger, so that the preset switching condition of the embodiment of the present disclosure may be operations of two fingers and etc. The embodiment of the present disclosure does not specifically limit the preset switching condition.

In an embodiment of the present disclosure, the storage object can be lightweight storage SharedPreference. When the second application is established in the SharedPreference, right of the SharedPreference can be set as being readable and rewritable by other applications, where the other applications may include the first application; thus, when the sliding operation on the touch screen from the user satisfies the preset switching condition, the first application modifies the SharedPreference according to change of the wallpaper switching control, where modification on the SharedPreference may be modification on the wallpaper management service identifier in the SharedPreference.

Step 303, the first application sends the modification notification information of the storage object to the second application.

In conclusion, according to the wallpaper switching method provided by the embodiment of the present disclosure, the first application monitors the sliding operation on the touch screen from the user. When the operation is the sliding operation meeting the preset switching condition, the first application may modify the pre-associated storage object according to the operation and send the modification notification information of the storage object to the second application, so that the second user receiving the modification notification information acquires the wallpaper switching identifier in the storage object and determines whether the wallpaper management service is on or off according to the identifier. Compared with the defect in the prior art, where the switching flow is tedious as the switch for switching the wallpaper is located the functional levels such as wallpaper application or mobile phone settings, in the embodiment of the present disclosure, switching of the wallpaper management service of the second application can be accomplished through the first application, and the first application may be an application capable of displaying the wallpaper, for example, a screen-locking application or a desktop application, so that switching of the wallpaper management service can be realized without entering the functional levels such as wallpaper application or mobile phone settings in the embodiment of the present disclosure. Therefore, the wallpaper switching flow can be simplified, so that the wallpaper switching efficiency can be improved.

### Fourth Embodiment of the Method

With reference of FIG. 5, the step flow diagram of the fifth embodiment of the wallpaper switching method according to the present disclosure is illustrated. The method can specifically include the steps as below.

Step 501, a second application receives the modification notification information of the storage object from the first application, where the storage object is the storage object of the wallpaper management service identifier of the second application.

In the embodiment of the present disclosure, the second application can be an application providing the wallpaper management service. The first application may be an application capable of displaying the wallpaper and can monitor operations on the touch screen from the user, and further can display the wallpaper switching control; thus, after monitoring that the operations on the touch screen from the user satisfy the preset switching condition or receiving the operation with respect to the wallpaper switching control from the user, the first application can modify the pre-associated storage object according to the operation and can send the modification notification information of the storage object to the second application, so that the second application realizes switching of the wallpaper management service.

In the embodiment of the present disclosure, the modification notification information is used for informing the second application that the storage object is changed. The storage object is used for storing the wallpaper management service identifier corresponding to the preset switching condition or the state of the wallpaper switching control, where the wallpaper management service identifier can be used for identifying whether the wallpaper management service is on or off.

In an embodiment of the present disclosure, the storage object can be lightweight storage SharedPreference. When the second application is established in the SharedPreference, right of the SharedPreference can be set as being readable and rewritable by other applications, where the other applications may include the first application; thus, when the operations on the touch screen from te user satisfy the preset switching condition or the state of the wallpaper switching control is changed, the first application modifies the SharedPreference according to the preset switching condition or change of the wallpaper switching control, where modification on the SharedPreference may be modification on the wallpaper management service identifier in the SharedPreference.

It is understandable that the SharedPreference is only an example of the storage object rather than limitation on the storage object. Actually, assemblies in the application capable of storing the wallpaper switching identifier are feasible, for example, a light weight database SQfile, a native object File, a broadcast Network and etc.; therefore, the embodiment of the present disclosure does not limit the storage object.

Step 502, the second application receiving the modification notification information of the storage object reads the storage object.

In a specific embodiment, the modification notification information can carry identifier information of the storage object, thus, when receiving the modification notification information, the second application can read the current content of the storage object according to the identifier information of the storage object, and the read current content is the value of the storage object corresponding to the wallpaper management service identifier.

In an embodiment of the present disclosure, the second application may receive broadcast messages sent by other applications by invoking the broadcast receiver, wherein the broadcast messages sent by other applications may include the modification notification information sent by the first application, that is, the second application may receive modification notification information broadcast sent by the first application in a broadcast mode.

It is understandable that the broadcast mode is only an example of a receiving mode for receiving the modification notification information from the first application by the second application rather than application limitation on the receiving mode. Actually, the modes for realizing communication between two processes can be used as the receiving modes. The modes for realizing communication between two processes can specifically include Activity, Content Provider, AIDL (Android Interface definition language) etc. The embodiment of the present disclosure does not limit the specific receiving modes.

Step 503, the second application switches the wallpaper management service according to the read result of the storage object.

In an optional embodiment of the present disclosure, assuming that the wallpaper management service identifier has two states: being on and off, the read result can specifically include the two states: being on and off correspondingly, when the read result of the storage object is on, the wallpaper management service can be turned on, so that the user switch the wallpaper by way of shaking the mobile phone or by way of sliding the mobile phone screen; or, when the read result of the storage object is off, the wallpaper management service can be turned off.

In conclusion, according to the wallpaper switching method provided by the embodiment of the present disclosure, the first application monitors the operation of the user on the touch screen. When the operation is the sliding operation meeting the preset switching condition, or the operation is the operation with respect to the wallpaper switching control, the first application can modify the pre-associated storage object according to the operation and send the modification notification information of the storage object to the second application, so that the second user receiving the modification notification information acquires the wallpaper switching identifier in the storage object and determines whether the wallpaper management service is on or off according to the identifier. Compared with the defect in the prior art, where the switching flow is tedious as the switch for switching the wallpaper is located the functional levels such as wallpaper application or mobile phone settings, in the embodiment of the present disclosure, switching of the wallpaper management service of the second application can be accomplished through the first application, and the first application may be an application capable of displaying the wallpaper, for example, a screen-locking application or a desktop application, so that switching of the wallpaper management service can be realized without entering the functional levels such as wallpaper application or mobile phone settings in the embodiment of the present disclosure. Therefore, the wallpaper switching flow can be simplified, so that the wallpaper switching efficiency can be improved.

To better understand the embodiment of the present disclosure by the technical staff in the field, the wallpaper switching method provided by the embodiment of the present disclosure is illustrated by specific examples below.

In an application example 1 of the present disclosure, assuming that the first application is the screen-locking application, that is, the screen-locking application monitors the sliding operation on the touch screen from the user, or the screen-locking application displays the wallpaper switching control on the screen-locking interface, the user may perform the sliding operation or turn on the wallpaper switching control along the direction 1 shown in the FIG. 4 during wallpaper switching, so that the screen-locking application changes the storage object of the wallpaper application to be turned on, and therefore, the wallpaper application starts the wallpaper management service according to the state of the storage object. In such a case, the user may switch the wallpaper by way of shaking the mobile phone or by way of sliding the mobile phone screen; when the user's satisfied wallpaper is displayed, the user may directly perform the sliding operation or turn off the wallpaper switching control along the direction 2 shown in the FIG. 4 on the screen-locking interface, so that the screen-locking application changes the storage object of the wallpaper application to be turned off, and therefore, the wallpaper application turns off the wallpaper management service according to the state of the storage object; it can be seen that the user can realize switching of the wallpaper management service without entering the functional levels such as wallpaper application or mobile phone settings.

In an application example 2 of the present disclosure, assuming that the first application is the desktop application, that is, the desktop application monitors the sliding operation on the touch screen from the user, or the desktop application displays the wallpaper switching control on the desktop, the user may perform the sliding operation or turn on the wallpaper switching control along the direction 1 shown in the FIG. 4 on the desktop during wallpaper switching, so that the desktop application changes the storage object of the wallpaper application to be turned on, and therefore, the wallpaper application starts the wallpaper management service according to the state of the storage object, and furthermore, the user may switch the wallpaper by way of shaking the mobile phone or by way of sliding the mobile phone screen; when the user's satisfied wallpaper is displayed, the user may directly perform the sliding operation or turn off the wallpaper switching control along the direction 2 shown in the FIG. 4 on the desktop, so that the desktop application changes the storage object of the wallpaper application to be turned off, and therefore, the wallpaper application turns off the wallpaper management service according to the state of the storage object; it can be seen that the user can realize switching of the wallpaper management service without entering the functional levels such as wallpaper application or mobile phone settings.

Compared with the defect that in the prior art, the switching flow is tedious as the switch for switching the wallpaper is located the functional levels such as wallpaper application or mobile phone settings, in the two examples according to the embodiment of the present disclosure, the operation on the touch screen from the user can be monitored through the first application, so that switching of the wallpaper management service is accomplished according to the operation. Therefore, switching of the wallpaper management service can be realized without entering the functional levels such as wallpaper application or mobile phone settings in the embodiments of the present disclosure. Therefore, the wallpaper switching flow can be simplified, so that the wallpaper switching efficiency can be improved.

### First Embodiment of the Device

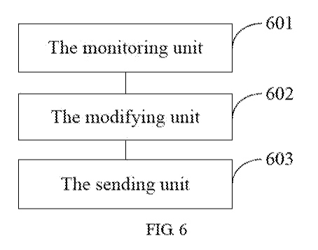

With reference of the FIG. 6, a structural schematic diagram of a first embodiment of the wallpaper switching device according to the present disclosure is illustrated. The device may specifically include a monitoring unit 601, a modifying unit 602 and a sending unit 601.

It should be noted that the embodiment of the present disclosure can be applied to a first application of a mobile terminal, wherein the first application may be an application for displaying the wallpaper.

The monitoring unit 601 may be used for monitoring an operation on a touch screen from a user.

The modifying unit 602 may be used for modifying a pre-associated storage object according to the operation by the first application, when the operation is a sliding operation meeting a preset switching condition, or, the operation is an operation with respect to a wallpaper switching control; the storage object is a storage object of a wallpaper management service identifier of a second application.

The sending unit 603 may be used for sending the modification notification information of the storage object to the second application.

Where the second application may be an application providing the wallpaper management service.

In an embodiment of the present disclosure, the wallpaper switching control may be a switch, or, check boxes.

In an embodiment of the present disclosure, the storage object may specifically include a lightweight storage, a lightweight database, a native object and a broadcast network.

In an embodiment of the present disclosure, the sliding operation meeting the preset switching condition includes a vertical sliding operation on the touch screen.

### Second Embodiment of the Device

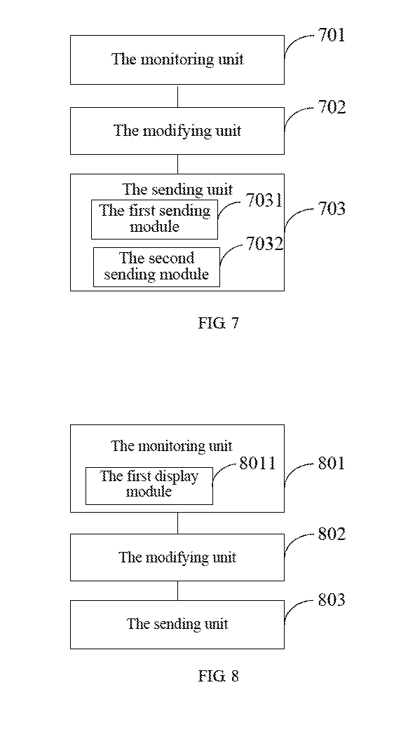

With reference of the FIG. 7, a structural schematic diagram of a second embodiment of the wallpaper switching device according to the present disclosure is illustrated. The device may specifically include a monitoring unit 701, a modifying unit 702 and a sending unit 703.

It should be noted that the embodiment of the present disclosure can be applied to a first application of a mobile terminal, wherein the first application may be an application for displaying the wallpaper.

The monitoring unit 701 may be used for monitoring an operation of a user on a touch screen.

The modifying unit 702 may be used for modifying a pre-associated storage object according to the operation by the first application, when the operation is a sliding operation meeting a preset switching condition, or, the operation is an operation with respect to a wallpaper switching control; the storage object is a storage object of a wallpaper management service identifier of a second application.

The sending unit 703 may be used for sending the modification notification information of the storage object to the second application.

The sending unit 703 may specifically include a first sending module 7031 and a second sending module 7032.

The first sending module 7031 is used for sending the modification notification information of the storage object to the second application in a broadcast mode; or
the second sending module 7032 is used for sending the modification notification information of the storage object to the second application in a content provider mode.

### Third Embodiment of the Device

With reference of the FIG. 8, a structural schematic diagram of a third embodiment of the wallpaper switching device according to the present disclosure is illustrated. The device may specifically include a monitoring unit 801, a modifying unit 802 and a sending unit 803.

It should be noted that the embodiment of the present disclosure can be applied to a first application of a mobile terminal, wherein the first application may be an application for displaying the wallpaper.

The monitoring unit 801 may be used for monitoring an operation on a touch screen from a user;

The modifying unit 802 may be used for modifying a pre-associated storage object according to the operation by the first application, when the operation is a sliding operation meeting a preset switching condition, or, the operation is an operation with respect to a wallpaper switching control; the storage object is a storage object of a wallpaper management service identifier of a second application.

The sending unit 803 may be used for sending the modification notification information of the storage object to the second application.

The monitoring unit 801 may specifically include:
a first display module 8011 which may be used for displaying the wallpaper switching control on the screen-locking interface.

In another embodiment of the present disclosure, the monitoring unit 801 further may specifically include a second display module which may be used for displaying the wallpaper switching control on the desktop.

### Fourth Embodiment of the Device

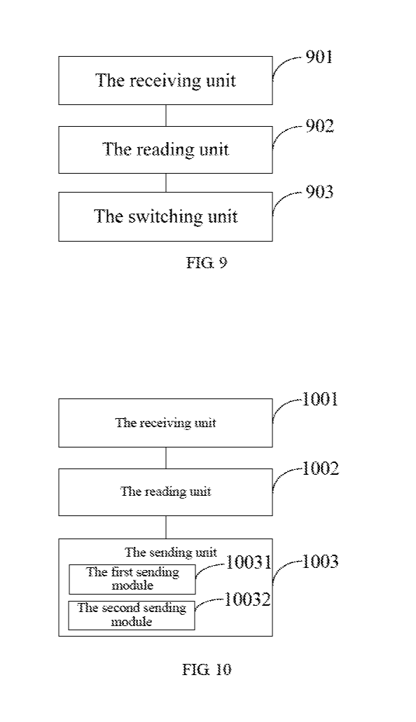

With reference of the FIG. 9, a structural schematic diagram of a fourth embodiment of the wallpaper switching device according to the present disclosure is illustrated. The device can specifically include a receiving unit 901, a reading unit 902 and a switching unit 903.

It should be noted that the embodiment of the present disclosure can be applied to a second application of a mobile terminal, wherein the second application may be an application for providing the wallpaper management service.

The second receiving unit 901 is used for receiving the modification notification information of the storage object from the first application, wherein the storage object is the storage object of the wallpaper management service identifier of the second application.

The reading unit 902 is used for reading the storage object after receiving the modification notification information of the storage object; and the switching unit 903 is used for switching the wallpaper management service according to the read result of the storage object.

In an embodiment of the present disclosure, the storage object may specifically include a lightweight storage, a lightweight database, a native object and a broadcast network.

In another embodiment of the present disclosure, the first application is a screen-locking application or a desktop application.

### Fifth Embodiment of the Device

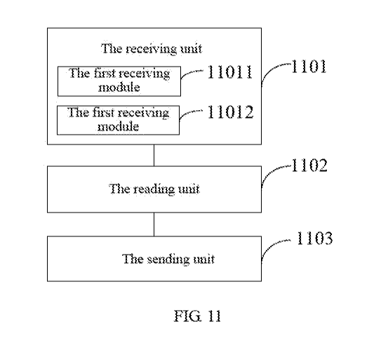

With reference of the FIG. 10, a structural schematic diagram of a fifth embodiment of the wallpaper switching device according to the present disclosure is illustrated. The device can specifically include a receiving unit 1001, a modifying unit 1002 and a sending unit 1003.

It should be noted that the embodiment of the present disclosure can be applied to a second application of a mobile terminal, wherein the second application may be an application for providing the wallpaper management service.

The receiving unit 1001 is used for receiving the modification notification information of the storage object from the first application, the storage object is the storage object of the wallpaper management service identifier of the second application.

The reading unit 1002 is used for reading the storage object after receiving the modification notification information of the storage object.

The switching unit 1003 is used for switching the wallpaper management service according to the read result of the storage object.

The switching unit 1003 may specifically include:
a first switching module 10031 for turning on the wallpaper management service when the read result of the storage object is on; or
a second switching module 10032 for turning off the wallpaper management service when the read result of the storage object is off.

### Sixth Embodiment of the Device

With reference of the FIG. 11, a structural schematic diagram of a sixth embodiment of the wallpaper switching device according to the present disclosure is illustrated. The device may specifically include a receiving unit 1101, a reading unit 1102 and a switching unit 1103.

It should be noted that the embodiment of the present disclosure can be applied to a second application of a mobile terminal, wherein the second application may be an application for providing the wallpaper management service.

The second receiving unit 1101 is used for receiving the modification notification information of the storage object from the first application, the storage object is the storage object of the wallpaper management service identifier of the second application.

The reading unit 1102 is used for reading the storage object after receiving the modification notification information of the storage object.

The switching unit 1103 is used for switching the wallpaper management service according to the read result of the storage object.

The receiving unit 1101 may specifically include:
a first receiving module 11011 for receiving the modification notification information of the storage object sent by the first application in a broadcast mode; and/or
a second receiving module 11012 for receiving the modification notification information of the storage object sent by the first application in a content provider mode.

The illustrated embodiments of the device are only schematic. The units illustrated as separated parts can be or cannot be physically separated. The parts displayed as units can be or cannot be physical units, that is, the parts can be located in a same place, or further can be distributed to a plurality of network units. Part of or all of the modules can be selected according to actual needs to realize the purpose of the embodiments of the present disclosure. The ordinary technical staff in the field can understand and implement the embodiments of the present disclosure on the premise of not contributing creative labor.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the interne websites, or be provided in carrier, or be provided in other manners.

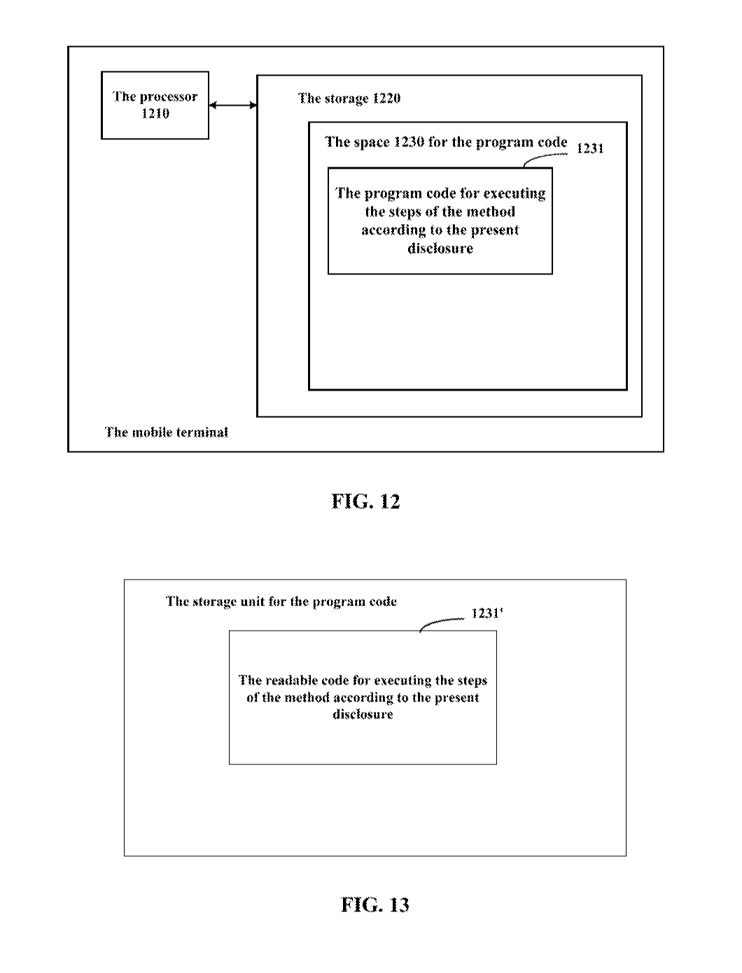

For example, FIG. 12 illustrates a block diagram of a mobile terminal for executing, the method according the disclosure. Traditionally, the mobile terminal includes a processor 1210 and a computer program product of a computer readable medium in form of a memory 1220. The memory 1220 could be electronic memories such as flash memory, EEPROM (Electrically Erasable Programmable Read-Only Memory), EPROM, hard disk or ROM. The memory 1220 has a memory space 1230 for executing program codes 1231 of any steps in the above methods. For example, the memory space 1230 for program codes may include respective program codes 1231 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 13. The memory cells may be provided with memory sections, memory spaces, etc., similar to the memory 1220 of the server as shown in FIG. 12. The program codes may be compressed for example in an appropriate form. Usually, the memory cell includes computer readable codes 1231′ which can be read for example by processors 1210. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that the embodiments are only used for illustrating the technical scheme of the present disclosure rather than limiting the technical scheme. In spite of illustrating the present disclosure in detail with reference to the embodiments, the ordinary technical staff in the field should understand that the ordinary technical staff in the field still can modify the technical scheme recorded in the embodiments or perform equivalent replacement on part of technical characteristics therein. It will be appreciated that those modifications or variations of the present disclosure do not make the essence of the corresponding technical scheme depart from the spirit or scope of the present disclosure.

What is claimed is:

1. A wallpaper switching method, applied to a terminal, comprises:
monitoring an operation on a touch screen from a user;
when the operation is a sliding operation which corresponding to a preset switching condition, or when the operation is an operation with respect to a wallpaper switching control, modifying a pre-associated storage object according to the operation, wherein the storage object is a storage object of a wallpaper management service identifier of an application; and
sending a modification notification information of the storage object to the application.

2. The method according to claim 1, wherein the wallpaper switching control is a switch or check boxes.

3. The method according to claim 1, wherein the sliding operation which corresponding to the preset switching condition comprises a vertical sliding operation on the touch screen.

4. The method according to claim 1, wherein the sending a modification notification information of the storage object to the application comprises:
sending the modification notification information of the storage object to the application in a broadcast mode; or
sending the modification notification information of the storage object to the application in a content provider mode.

5. The method according to claim 1, wherein the wallpaper switching control is displayed on a screen-locking interface of a screen-locking application.

6. The method according to claim 1, wherein the wallpaper switching control is displayed on an interface of a desktop application.

7. The method according to claim 1, wherein the storage object comprises a lightweight storage, a lightweight database, a native object and a broadcast network.

8. The method according to claim 1, wherein the application is an application for providing wallpaper management service.

9. A mobile terminal for wallpaper switching, comprising:
at least one processor; and
a memory communicably connected with the at least one processor for storing instructions executable by the at least one processor, wherein execution of the instructions by the at least one processor causes the at least one processor to:
monitoring an operation on a touch screen from a user;
when the operation is a sliding operation which corresponding to a preset switching condition, or, when the operation is an operation with respect to a wallpaper switching control, modifying a pre-associated storage object according to the operation, wherein the storage object is a storage object of a wallpaper management service identifier of an application; and
sending a modification notification information of the storage object to the application.

10. The mobile terminal according to claim 9, wherein the wallpaper switching control is a switch or check boxes.

11. The mobile terminal according to claim 9, wherein the sliding operation which corresponding to the preset switching condition comprises a vertical sliding operation on the touch screen.

12. The mobile terminal according to claim 9, wherein the sending a modification notification information of the storage object to the application comprises:
sending the modification notification information of the storage object to the application in a broadcast mode ; or
sending the modification notification information of the storage object to the application in a content provider mode.

13. The mobile terminal according to claim 9, wherein the wallpaper switching control is displayed on a screen-locking interface of a screen-locking application.

14. The mobile terminal according to claim 9, wherein the application is an application for providing the wallpaper management service.

15. A non-transitory computer-readable storage medium storing executable instructions that, when executed by an electronic device with a touch-sensitive display, cause the electronic device to:
monitor an operation on a ouch screen from a user;
when the operation is a sliding operation which corresponding to a preset switching condition, or, when the operation is an operation with respect to a wallpaper switching control, modify a pre-associated storage object according to the operation. wherein the storage object is a storage object of a wallpaper management service identifier of an application; and
send a modification notification information of the storage object to the application.

16. The non-transitory computer-readable storage medium according to claim 15, wherein the wallpaper switching control is a switch or check boxes.

17. The non-transitory computer-readable storage medium according to claim 15, wherein the sliding operation which corresponding to the preset switching condition comprises a vertical sliding operation on the touch screen.

18. The non-transitory computer-readable storage medium according to claim 15, wherein the send a modification notification information of the storage object to the application comprises:
sending the modification notification information of the storage object to the application in a broadcast mode; or
sending the modification notification information of the storage object to the application in a content provider mode.

19. The non-transitory computer-readable storage medium according to claim 15, wherein the wallpaper switching control is displayed on a screen-locking interface of a screen-locking application.

20. The non-transitory computer-readable storage medium according to claim 15, wherein the wallpaper switching control is displayed on an interface of a desktop application.
